(19) United States
(12) Patent Application Publication
(10) Pub. No.: US 2016/0285885 A1
(43) Pub. Date: Sep. 29, 2016

(54) CONTEXTUAL CONTACTS FOR HTML5

(71) Applicant: INTEL CORPORATION, Santa Clara, CA (US)

(72) Inventors: Rita H. WOUHAYBI, Portland, OR (US); Hong LI, EI Dorado Hills, CA (US); Lama NACHMAN, Santa Clara, CA (US)

(21) Appl. No.: 15/038,691

(22) PCT Filed: Dec. 23, 2013
(86) PCT No.: PCT/US2013/077496

§ 371 Date: May 23, 2016

(51) Int. Cl. H04L 29/06; G06F 17/30

(52) U.S. Cl. CPC H04L 63/104; H04L 63/102; G06F 17/30477; G06F 17/30528; G06F 17/30345

(57) ABSTRACT

Various system and methods for selecting a set of contacts for sharing with an application. An apparatus comprises a contact selection module, an application analysis module, and a contact manager module. The contact selection module receives a request at a computing device, from an application, to access contacts stored on the computing device. The application analysis module determines a set of contexts of the application. The contact manager module generate a a set of contacts to share with the application based on the set of contexts, wherein the set of contacts have contexts correlated with the set of contexts of the application; and grants access to the set of contacts to the application.

### BACKGROUND

When a user installs an application on his or her phone, the application may request permission to access data on the phone. For example, the application may request access to calls the user has made as well as contacts of the user. Besides user installable applications, web-based applications may also request access to information of the user, such as location information.

### BRIEF DESCRIPTION OF DRAWINGS

Some embodiments are illustrated by way of example and not limitation in the figures of the accompanying drawings in which:

FIG. 1 is a schematic diagram illustrating a contact access request, according to example embodiment;

FIG. 2 is a schematic diagram illustrating a computing device, according to an example embodiment;

FIG. 3 is a flow chart illustrating a method to monitor contact interactions, according to an example embodiment;

FIG. 4 is a flow chart illustrating a method to suggest contact access for an application, according to an example embodiment; and

FIG. 5 is a block diagram of machine in the example form of a computer system within which a set instructions, for causing the machine to perform any one or more of the methodologies discussed herein, may be executed.

### DETAILED DESCRIPTION

As a user browses the Internet, the user may encounter a request to access information about the user or the computing device the user is using. For example, if a user is on a retail website, the website may request location information of the computing device to point the user in the direction of the closest store to the user's location. Similarly, a web application may request access to a user's contact, however, this may be a binary option. In other words, the user may grant access to all of his or her contacts, or none. A user may have hesitation, potentially ever more so than traditional downloaded phone applications, about granting access to all contacts stored on the user's phone. Thus, it may be advantageous to restrict access to only a subset of contacts when a web-application, or traditional installed application, requests such access.

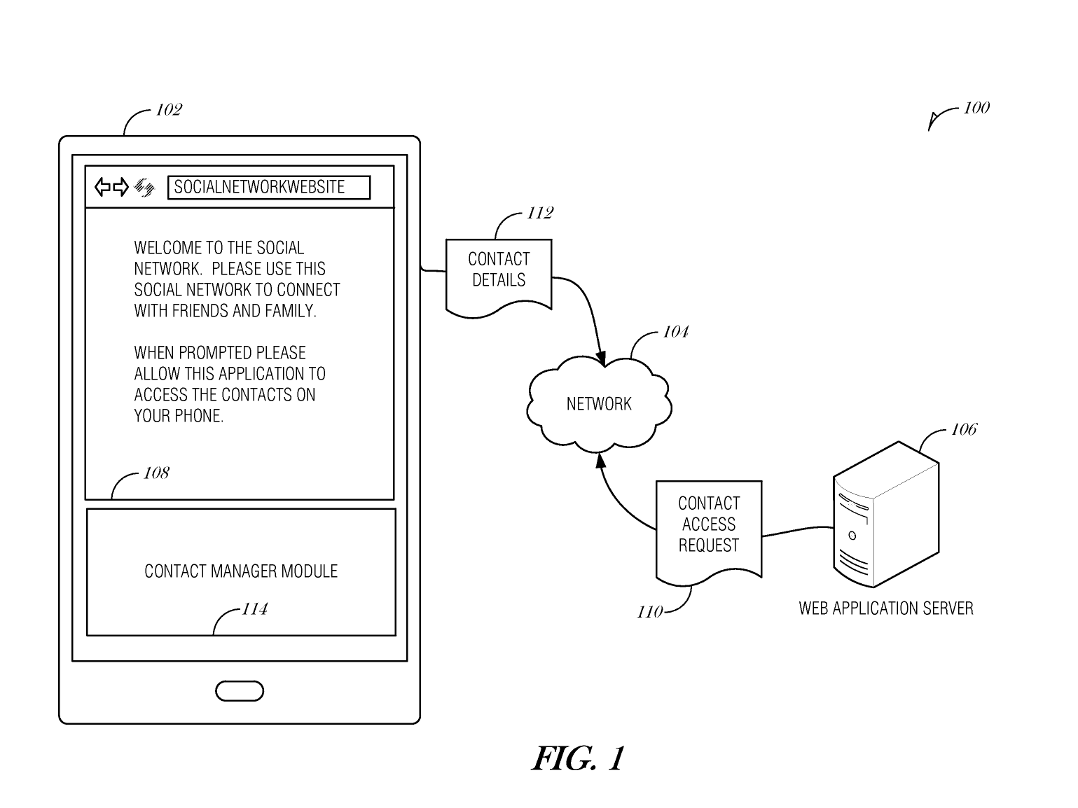

FIG. 1 is a schematic diagram 100 illustrating a contact access request, according to an example embodiment. The diagram 100 includes a computing device 102, a network 104, a web application server 106, an application 108, a contact access request 110, a contact details response 112, and a contact manager module 114. While functionality of the depicted devices is described with respect to particular modules, functionality may be performed by other modules or combined with other modules. Similarly, the labels of the modules are for illustration purposes and other labels may be used.

In various examples, the computing device 102 is a mobile computing device such as a mobile phone or tablet computer, however, the computing device may also be a laptop or personal computer. The computing device 102 may include a storage device and at least one processor (e.g., single core, multicore, multiple processor), wherein the processor is configured to execute instructions stored on the storage device to perform functionality described herein.

The user may use a web browser application to navigate to the application 108. The application 108 may be a web-based application, such as, but not limited to a social media application, a game, or a business application. As illustrated, the application 108 is asocial network application that directs the user to connect with friends and family. In an example, the application 108 may be compliant with a HyperText Markup Language (HTML) standard, such as a HTML5.

In various examples, the application 108 is hosted by the web application server 106. The web application server 106 may respond to a request by the computing device 102 and transmit files that are rendered on the computing device 102 that represent the application 108. A user may interact with the application 108 on the computing device 102, and, in some instances, the interactions may be transmitted back to the web application server 106. in various examples, a user may interact with the application 108, and the application 108 may update without communicating with the web application server 106.

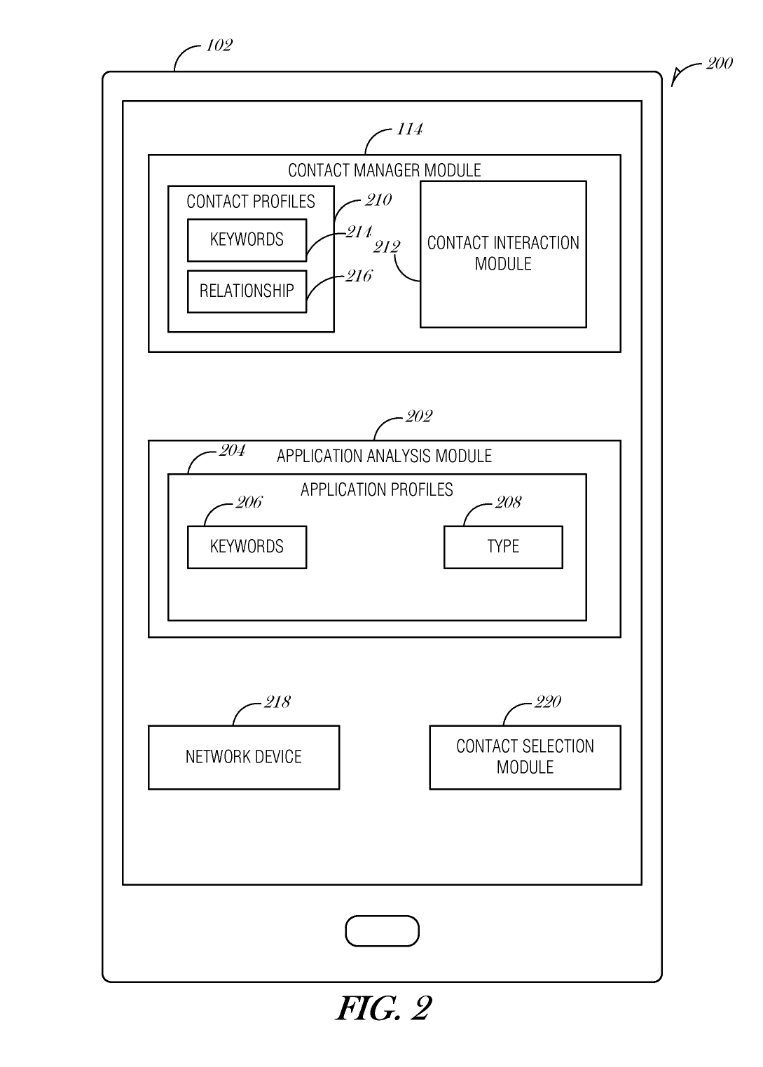

In various examples, the application 108 may request access to data stored on the computing device 102. For example, the web application 108 may request access to contacts stored on the computing device 102. The request may originate locally from the application 108 or from the web application server 106 (i.e., the contact access request 110). The computing device 102 may direct the contact access request to the contact manager module 114 to determine which contacts to share with the application 108. In an example, the request is an HTML5 compliant access request. The contact manager module 114 may utilize the context (e.g., purpose) of the application 108 to select the set of contacts. For example, different contexts may have stored mappings to different sets of contacts. In an example, the application 108, via the computing device 102, may transmit the contacts details 112 to the web application server 106. Further details of how the contact manager module 114 selects the set of contacts are discussed with respect to FIG. 2. In various examples, when the set of contacts is determined, the computing device 102 may store a record indicating the application 108 has access to the set of contacts.

The network 104 may include local-area networks (LAN), wide-area networks (WAN), wireless networks (e.g., 802.11 or cellular network), the Public Switched Telephone Network (PSTN) network, ad hoc networks, personal area networks (e.g., Bluetooth®) or other combinations or permutations of network protocols and network types. The network 104 may include a single local area network (LAN) or wide-area network (WAN), or combinations of LAN's or WAN's, such as the Internet. The various devices coupled to the network 104 may be coupled via one or more wired or wireless connections.

FIG. 2 is a schematic diagram 200 illustrating a computing device 102, in accordance with an example embodiment. The computing device 102 includes, the contact manager module 114, the contact profiles 210 including keywords 214 and relationship 216, a contact interaction module 212, an application analysis module 202, the application profiles 204 with keywords 206 and a type 208, a network device 218, and a contact selection module 220.

In various examples, the contact manager module 114 is located in a layer between an HTML5 application and an existing contacts application on the computing device 102. In an example, the functionality of the contact interaction module 212 is built into the existing contacts application on the computing device 102. In an example the contact manager module 114 is an extension of a browser running on the computing device 102. The contact interaction module 212 may analyze interactions from multiple applications with contacts made by the user or existing applications and build or update contact profiles 210 based on the interactions.

The keywords 214 of the contact profiles 210 may be one of more terms that define or are indicative of a particular contact's relationship with the user of the computing device 102. In an example, the relationship 216 indicates a relative level of closeness between a contact and the user, The level may be measured on a numerical scale (e.g., 0-10 with 10 being very close) qualitative (e.g., family, friend-of-friend, etc.) Of contextual (e.g., tennis, gardening, computer science, etc.). A contact could have multiple contexts assigned to them. Collectively, the keywords 214 and the relationship 216 within a profile may be considered a “context,” also referred to as a category or purpose of the contact, with respect to the user of the computing device 102. Contacts with like contexts may be grouped together. Then, when an application with a similar context to the group requests access to the contacts, the contact manager module 114 may grant access to the grouped contacts. There may be one contact profile for each contact in the contacts application on the computing device. The contact profiles 210 may be stored in a storage device (e.g., relational database, flat file database, individual files).

As with the contact interaction module 212, application analysis module 202 may maintain profiles for various applications. The application profiles 204 may include the keywords 206 that describe the application as well as an overall type 208 (e.g., business, etc.). In various examples, a type 208 may also be a keyword. Similarly, the combination of the keywords 206 and the type 208 may be considered an application context or its category/purpose. There may be an application profile 204 for each web-application the user has used, and may be identified by the Uniform Resource Locator (URL) of the application or name of the application, in various examples. The application profiles 204 may be stored in a storage device (e.g., relational database, flat file database, individual files).

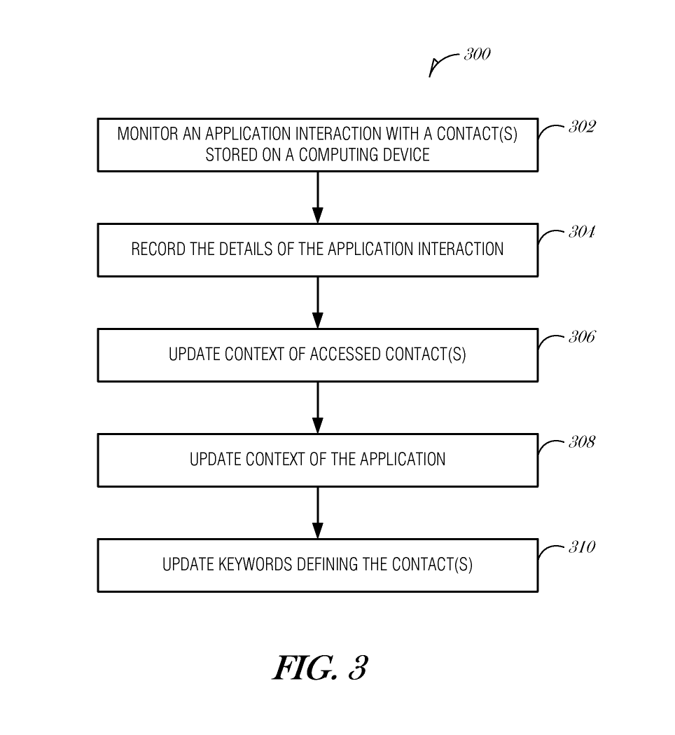

FIG. 3 is a flow chart 300 illustrating a method to monitor contact interactions, according to various examples. While the operation blocks 302-310 are shown in an example flow, the operations may be performed in other orders. The method 300 may be performed by any of the modules, logic, or components described herein.

In various examples, at block 302, application interaction with a contact(s) stored on a computing device are monitored. For example, the contact interaction module 212 and the application analysis module 202 may utilize various input sources in order to maintain the contact profiles 210 and application profiles 204. Input sources may include communication activity on the computing device, social network interactions, online searches of the contacts, cloud information services concerning an application.

In an example, the communication activity includes communications made on the computing device itself. For example, the communication activity may include phone calls, emails, SMS, IMs, edits to the contact within the contacts application, etc., that the user may have with the contacts. Social network activity may also be monitored to determine which, if any social networks a contact is a part of as well as communications made with the contact via the social networks. In various examples, the contact interaction module 212 may perform online searches of external information sources (e.g., public databases) to gather additional demographic, including location, or interest information about a contact and the online persona he or she is trying to maintain. Cloud information services may provide information on an application such as the purpose of the application and its reputation or trust worthiness.

In various examples, at block 304, the details (e.g., information gathered) of the application interaction are recorded. An interaction may be a monitored event using one or more of the input sources. The details of the interaction may include, but are not limited to:
Frequency and time of contact
Sentiment analysis of content exchanged (Casual, Business, etc.,) using natural language processing algorithms
Types of contact and communication
Topics discussed during contact
Response time by the user (does the user consider it their highest priority to answer the contact person or take his/her time in responding)
How was this contact added to the contacts app (automated vs. manual entry)?
Age, gender and other general demographics of the contact including state and city for their home location.
The nature (e.g., social, business, messaging, etc.) and trustworthiness (reputation, historical behavior, importance) of an application requesting access to contact information
The purpose of requested access by an application. This may be used to decide specifically which of the contacts, and what portion of the contacts are to be shared

In various examples, at block 306, the context/category of a contact may be refined based on the application interaction. For example, if the analysis of an e-mail communication with a contact is determined (e.g., using keyword analysis) to be for scheduling a business meeting, the context of the contact may be set to a business associate. In various examples, there may be more than one context or category for a contact. For example, for each type of context or category there may be a value indicating the relative likelihood (e.g., on a scale of 0-1) that the contact is part of a particular context. For example, for a contact may have a 0.05 rating as a business contact and a 0.4 as a family contact. These values may change based upon the monitored interactions or from user input such as a user indicating the context of a contact manually.

In various examples, at block 308, the context/purpose of an application may he updated based on the application interaction. As with the contacts, information leaned during the application interaction may be used to update relative values for a context. Additionally, the information may be used to update the keywords 206 and the type 208 of an application as needed. For example cloud information services may provide keywords that define the purpose of the application. In various examples, the type 208 may also be a keyword. As an application may have a set (e.g., one or more) of contexts, more than one context may be updated based on the application interaction,

In various examples, at block 310, keywords defining the contacts assay be updated. For example, keyword may be extracted from communications made between the contact the user of the computing device 102. These keywords may be correlated with topics the user and the contact have discussed. Subsequently, when an application requests access to a set of contacts, the keywords 214 may be compared with the keywords 206 of an application to determine the contacts relevance with respect to the application. Keyword matching may be used as a more granular match, or separate match, as contrasted with a broader context match (e.g., a business context vs. business application for car purchasing and contacts with keywords of “vehicles” and “sales”).

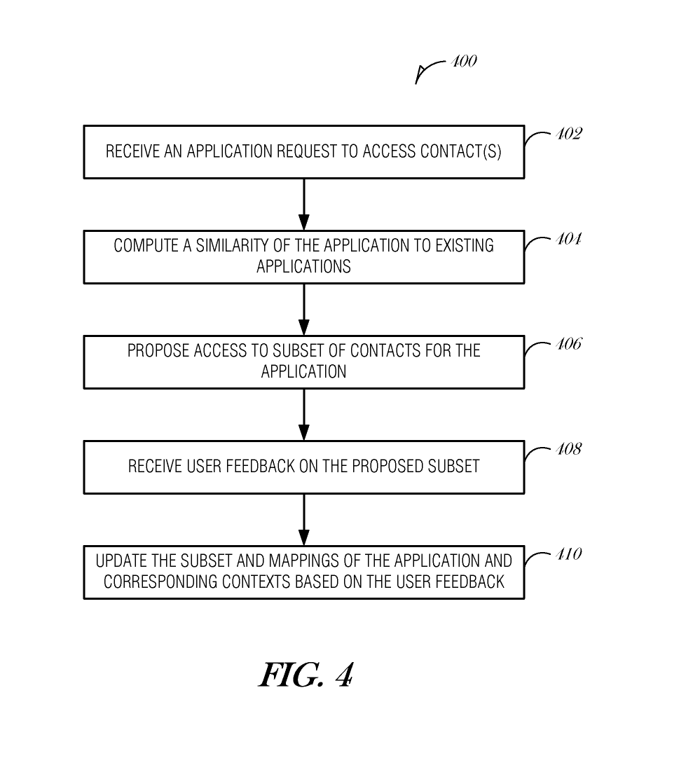

FIG. 4 is a flow chart illustrating a method 400, in accordance with an example embodiment, to suggest contact access for an application. While the operation blocks 402-410 are shown in an example flow, the operations may be performed in other orders. The method 400 may be performed by any of the modules, logic, or components described herein.

In an example, at block 402, an application request to access contact(s) is received. The application may be an HTML5 application the user has browsed to and connected with via the network device 218 of the computing device 102. The request may be directed towards the contacts application of the computing device 102. In an example, the request is intercepted by the contact selection module 220 for processing. The contact selection module 220 may communicate with the contact manager module 114 and application analysis module 202 to propose an initial subset of contacts to share with the application. From the viewpoint of the application, the request is being processed by the contacts application, in an example. Thus as far as the application is concerned, the contacts that are ultimately shared are all the contacts on the computing device 102. The contacts manager module 114 may choose to add fake contacts (i.e., contacts not added by the user) if needed.

In various examples, at block 404, the similarity of the requesting application to existing applications is computed. For example, consider that the HTML5 application has not been used before by the user and thus there is no application profile information. Semantic analysis of the application (e.g., text or HTML of the application, metadata in the HTML5 headers, a social networking resource or other online resources, etc.) may be used to generate a set of keywords that describe the application's context. The application analysis module 202 may compare this set of keywords with the keywords 206 to see if a similar application profile exists with a previously defined context. Similarities may also be computed based on other factors. For example, the developer of the requesting application may be compared with existing applications with the same developer, which may indicate a trust level (e.g., unknown, trustworthy, not-trustworthy) of the application based on the developer's previous behavior. The previous behavior may also be determined by accessing the online resources to see if the developer has had privacy breaches in the past. In various examples the user may provide feedback on the computed similarity. For example, the user may affirm that the computed similar application is similar to the current application or may choose another application. In an example, the user may be given the opportunity to define the context of the application using a presented user interface.

In an example, the application is not new and thus the application analysis module 202 may not need to compute a similarity. In such instances, a set of contexts associated with the application may be retrieved as stored in the application profile.

In various examples, at block 406, access to a subset of contact for the application is proposed to the user. This may be accomplished in a number of ways and different mechanisms may be used based on how much information is available to the contact manager module 114. For example, if the request is for an application that has a computed level of similarity above a threshold (e.g., matches more than 75% of keywords), the proposed subset of contacts may be the same as the similar application.

In various examples, when the user has not used many applications, there may not be a close context match with an existing application. In such situations, keywords resulting from a semantic analysis of the application may be compared with the keywords 214 to determine a context of the application and the proposed list of contacts. The semantic analysis may also be used determine the type of the application (e.g., is it a game, social network, etc.). Based on similarly typed applications (e.g., the type 208), contacts may be included or excluded from the proposed subset. Social networking applications, crowdsourcing, and other online resources can also be used to determine the type and context of the application.

In various examples, determining the proposed subset may include accessing data on other users of the application. For example, anonymized data of the context of users (for example, but not limited to, computer science, golf, environmental studies, etc.), and relationships shared with the application may be sent to a remote server. The remote server may be accessed by the computing device 102 to retrieve a relevant subset.

In various examples, an application context may be based on user feedback. For example, if there is not a close match with an existing application, an interface may be presented to the user that presents a user with a list (or other graphical element) of options for contacts to share with the application. The user may be presented with a list of the keywords 206 that the application analysis module 202 has determined for the application, alongside an option to select a context type of contact to share with the application. Individual contacts may also he selected for sharing that may be outside of a selected context. A user may also indicate a context of the application to help find the subset of contacts to share.

The presentation may include presenting the user's contacts in a set of circles (e.g., one circle for each relationship or context) or other graphical element that may be expanded to see which contacts are included in the relationship level. Similarly, a user may select one of the keywords to see contacts that include similar keywords in a contact profile. After a user is satisfied with his or her selection of contacts for the application, the user may confirm (e.g., selecting a confirmation input element) the subset of contacts to share with the application. The computing device 102 may store an association between the application and shared contacts for when the application requests access in the future. In an example, a subset may include all the contacts.

In various examples, the proposed subset is based on a mapping between a context/purpose of the application and contact profiles with a similar context/purpose. For example, if the context of the application is a forum for software development application then contacts that have a “computer science” keyword may be included in the subset.

In various examples, at block 408, user feedback concerning the proposed subset is received. The proposed subset may be presented to the user and the user may add or remove contacts from the subset. Once confirmed, the contacts details from the subset may be shared with the requesting application. Options may be presented with the confirmation request. For example, the user may specify that for a certain time period (e.g., a week, a month) no confirmation is needed to share the contacts with the application. Thus, in some examples, no feedback option is presented to a user after receiving an application request for contact details (e.g., name, phone number, address). Exceptions to a time limit may be set as well. For example, if a new contact is added to the computing device 102, the next time the application requests contact details, an option to include or exclude the contact from the subset may be presented. Another exception may be if the context of the application changes a new subset of contacts may be proposed or existing removed.

In various examples at block 410, the subset and mappings of the application and corresponding context are updated based on the user feedback. For example, as discussed above, a user may add or remove contacts from the subset. This in turn, may lead to possible changes in other applications that have a similar context to the requesting application. For example, if the context of the application is a racing game and a user adds a contact beyond those initially proposed, the computing device 102 may update a mapping or correlation between a “racing game” context to include the new contact. Similarly, the contact profile 210 of the contact may be modified to include a “racing game” keyword.

In various examples, more granular control is allowed with respect to the contact details that are shared with a requesting application. For example, certain contexts may be correlated with different sets or subsets of contact details. One context may be allowed to access only e-mail addresses while another may be able to access e-mail addresses and phone numbers of the contacts. User interfaces may be provided by the contact manager module 114 to select different contact details to share. In an example, when the proposed subset of contacts is presented to the user, the user may select the set of contact details to share with the application. In an example, a user may specify different contact details for different contacts.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

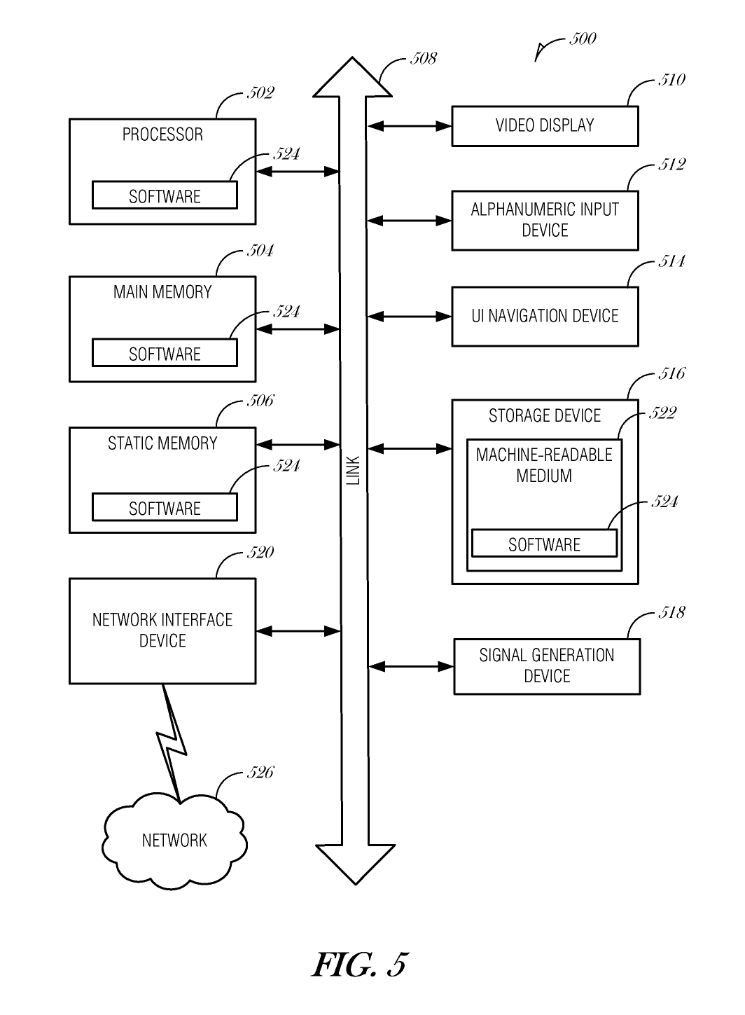

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 includes subject matter (such as a device, apparatus, or machine) comprising an apparatus to select a set of contacts for sharing with an application, the apparatus comprising: a contact selection module to receive a request at a computing device, from an application, to access contacts stored on the computing device; an application analysis module to determine a set of contexts of the application; and a contact manager module to: generate a set of contacts to share with the application based on the set of contexts, wherein the set of contacts have contexts correlated with the set of contexts of the application; and grant access to the set of contacts to the application.

In Example 2, the subject matter of Example 1 may optionally include, wherein to determine the set of contexts of the application, the application analysis module is to: perform keyword analysis of the application, wherein the application is a web-based application; and compare results of the keyword analysis with an application with a previously defined context.

In Example 3, the subject matter of any one or more of Examples 1 to 2 may optionally include, a context of the set of contexts of the application is selected from the group comprising: computer science, golf, tennis, and literature.

In Example 4, the subject matter of any one or more of Examples 1 to 3 may optionally include, wherein a context of the set of contexts is based on a trust level of the application.

In Example 5, the subject matter of any one or more of Examples 1 to 4 may optionally include, wherein the trust level is based on a developer of the application and the developer's previous behavior.

In Example 6, the subject matter of any one or more of Examples 1 to 5 may optionally include, wherein the contact selection module is to present the set of contacts to a user of the computing device before granting access to the set of contacts to the application.

In Example 7, the subject matter of any one or more of Examples 1 to 6 may optionally include, wherein the contact selection module is to receive user input indicating a modification to the presented set of contacts.

In Example 8, the subject matter of any one or more of Examples 1 to 7 may optionally include, wherein the application analysis module is to update a context of the application based on the user input.

In Example 9, the subject matter of any one or more of Examples 1 to 8 may optionally include, wherein the contact manager module is to update a context of at least one contact of the set of contacts based on the user input.

In Example 10, the subject matter of any one or more of Examples 1 to 9 may optionally include, wherein the application is compliant with an HTML5 standard.

In Example 11, the subject matter of any one or more of Examples 1 to 10 may optionally include, wherein the computing device is a mobile phone.

In Example 12, the subject matter of any one or more of Examples 1 to 11 may optionally include, further comprising a contact interaction module to: monitor interactions of a user of the computing device with the contacts stored in the computing device; and update a profile of at least one contact of contacts stored on the computing device based on the interactions.

In Example 13, the subject matter of any one or more of Examples 1 to 12 may optionally include, wherein to update a profile, the contact interaction module is to update a predicted closeness value between the user and the at least one contact.

In Example 14, the subject matter of any one or more of Examples 1 to 13 may optionally include, wherein to update a profile, the contact interaction module is to update a set of keywords indicative of a context and a relationship between the user and the at least one contact.

In Example 15, the subject matter of any one or more of Examples 1 to 14 may optionally include, wherein the contact interaction module is to access external information sources to update a profile of the at least one contact.

In Example 16, the subject matter of any one or more of Examples 1 to 15 may optionally include, wherein the set of contacts includes at least one fake contact.

In Example 17, the subject matter of any one or more of Examples 1 to 16 may optionally include, wherein to grant access to the set of contacts to the application the contact manager module is to grant access to a subset of available contact details of the set of contacts.

In Example 18 the subject matter of any one or more of Examples 1 to 17 may optionally include, wherein to determine the set of contexts of the application, the application analysis module is to: access an online resource to determine a context of the set of contexts of the application.

Example 19 includes or may optionally be combined with the subject matter of any one of Examples 1-18 to include subject flatter for selecting a set of contacts for sharing with an application (such as a method, means for performing acts, machine readable medium including instructions that when performed by a machine cause the machine to performs acts, or an apparatus configured to perform) comprising: receiving a request at a computing device, from an application, to access contacts stored on the computing device; determining a context of the application; generating a set of contacts to share with the application based on the determining, wherein the set of contacts have profiles correlated with the context of the application; and granting access to the set of contacts to the application.

In Example 20, the subject matter of Example 19 may optionally include, wherein determining a context of the application comprises: performing keyword analysis of the application, wherein the application is a web-based application; and comparing results of the keyword analysis with at least one application with a previously defined context.

In Example 21, the subject matter of any one or more of Examples 19 to 20 may optionally include, wherein determining a context of the application comprises: selecting at least one context from a group of keywords.

In Example 22, the subject matter of any one or more of Examples 19 to 21 may optionally include, wherein determining the context of the application comprises: determining a trust level of the application.

In Example 23, the subject matter of any one or more of Examples 19 to 22 may optionally include, wherein the trust level is based on a developer of the application.

In Example 24, the subject matter of any one or more of Examples 19 to 23 may optionally include, presenting the set of contacts to a user of the computing device before granting access to the contacts to the application.

In Example 25, the subject matter of any one or more of Examples 19 to 24 may optionally include, receiving user input indicating a modification to the presented set of contacts by the user.

In Example 26, the subject matter of any one or more of Examples 19 to 25 may optionally include, updating the context of the application based on the user input.

In Example 27, the subject matter of any one or more of Examples 19 to 26 may optionally include, updating a profile of at least one contact of the set of contacts based on the user input.

In Example 28, the subject matter of any one or more of Examples 19 to 27 may optionally include, wherein the application is compliant with an HTML5 standard.

In Example 29, the subject matter of any one or More of Examples 19 to 28 may optionally include, wherein the computing device is a mobile phone.

In Example 30, the subject matter of any one or more of Examples 19 to 29 may optionally include, monitoring interactions of a user of the computing device with contacts stored on the computing device; and updating a profile of at least one contact of the contacts stored on the computing device based on the interactions.

In Example 31, the subject matter of any one or More of Examples 19 to 30 may optionally include, wherein updating a profile of at least one contact of the contacts stored on the computing device based on the interactions comprises: updating a predicted closeness value between the user and the at least one contact.

In Example 32, the subject matter of any one or more of Examples 19 to 31 may optionally include, wherein updating a profile of at least one contact of the contacts stored on the computing device based on the interactions comprises: updating a set of keywords indicative of a relationship between the user and the at least one contact.

In Example 33, the subject matter of any one or more of Examples 19 to 32 may optionally include, wherein determining a context of the application comprises: determining a context based on analyzing keywords from HTML of the application.

Example 34 includes or may optionally be combined with the subject matter of any one of Examples 1-33 to include an apparatus comprising means for performing any of the Examples 1-33.

Example 35 includes an apparatus to select a set of contacts for sharing with an application, the apparatus comprising: means for receiving a request at a computing device, from an application, to access contacts stored on the computing device; means for determining a context of the application; means for generating a set of contacts to share with the application based on the determining, wherein the set of contacts have profiles correlated with the context of the application; and means for granting access to the set of contacts to the application.

In Example 36, the subject matter of any one or more of Examples 1 to 18 may optionally include, wherein the request is an HTML5 compliant access request.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. A machine-readable medium including instructions to select a set of contacts for sharing with an application, which when executed by a machine, cause the machine to perform operations comprising:
receiving a request at a computing device, from an application, to access contacts stored on the computing device;
determining a context of the application;
generating a set of contacts to share with the application based on the determining, wherein the set of contacts have profiles correlated with the context of the application; and
granting access to the set of contacts to the application.

27. The machine-readable medium of claim 26, wherein determining a context of the application comprises:
performing keyword analysis of the application, wherein the application is a web-based application; and
comparing results of the keyword analysis with at least one application with a previously defined context.

28. The machine-readable medium of claim 26, wherein determining a context of the application comprises:
selecting at least one context from a group of keywords.

29. The machine-readable medium of claim 26, wherein determining the context of the application comprises:
determining a trust level of the application.

30. The machine-readable medium of claim 29, wherein the trust level is based on a developer of the application.

31. The machine-readable medium of claim 26, further comprising:
presenting the set of contacts to a user of the computing device before granting access to the contacts to the application.

32. The machine-readable medium of claim 31, further comprising:
receiving user input indicating a modification to the presented set of contacts by the user.

33. The machine-readable medium of claim 32, further comprising:
updating the context of the application based on the user input.

34. The machine-readable medium of claim 32, further comprising:
updating a profile of at least one contact of the set of contacts based on the user input.

35. The machine-readable medium of claim 26, wherein the application is compliant with an HTML5 standard.

36. An apparatus to select a set of contacts for sharing with an application, the apparatus comprising:
a contact selection module to receive a request at a computing device, from an application, to access contacts stored on the computing device;
an application analysis module to determine a set of contexts of the application; and
a contact manager module to:
generate a set of contacts to share with the application based on the set of contexts, wherein the set of contacts have contexts correlated with the set of contexts of the application; and
grant access to the set of contacts to the application.

37. The apparatus of claim 11, wherein to determine the set of contexts of the application, the application analysis module is to:
perform keyword analysis of the application, wherein the application is a web-based application; and
compare results of the keyword analysis with an application with a previously defined context.

38. The apparatus of claim 36, wherein the request is an HTML5 compliant access request.

39. The apparatus of claim 36, wherein a context of the set of contexts is based on a trust level of the application.

41. The apparatus of claim 39, wherein the trust level is based on a developer of the application and the developer's previous behavior.

41. The apparatus of claim 36, wherein the contact selection module is to present the set of contacts to a user of the computing device before granting access to the set of contacts to the application.

42. The apparatus of claim 41, wherein the contact selection module is to receive user input indicating a modification to the presented set of contacts.

43. The apparatus of claim 42, wherein the application analysis module is to update a context of the application based on the user input.

44. The apparatus of claim 36, wherein the application is compliant with an HTML5 standard.

45. An method to select a set of contacts for sharing with an application, the method comprising:
receiving a request at a computing device, from an application, to access contacts stored on the computing device;
determining a context of the application;
generating a set of contacts to share with the application based on the determining, wherein the set of contacts have profiles correlated with the context of the application; and
granting access to the set of contacts to the application.
